(19) United States
(12) Patent Application Publication
(10) Pub. No.: US 2026/0115584 A1
(43) Pub. Date: Apr. 30, 2026

(54) BUTTON STRUCTURE

(71) Applicant: CHENG UEI PRECISION INDUSTRY CO., LTD., New Taipei City (TW)

(72) Inventors: TSUNG-SHIH LEE, New Taipei City (TW); YI HSU, New Taipei City (TW)

(21) Appl. No.: 18/927,815

(22) Filed: Oct. 25, 2024

(51) Int. Cl. A63F 13/24

(52) U.S. Cl. CPC A63F 13/24

(57) ABSTRACT

A button structure includes a button, a supporting base and a circuit board. The button has a pressing portion, an elastic arm and a trigger portion. The elastic arm is extended rearward from one side of a rear of the pressing portion, and then is bent sideward, and then is extended frontward. The trigger portion is extended rearward from the rear of the pressing portion. The trigger portion is disposed beside the elastic arm. The supporting base disposed to a rear of the button. The supporting base has a surrounding wall and a fastening pillar. The fastening pillar is disposed in the surrounding wall. The elastic arm is disposed in the surrounding wall and is disposed between the surrounding wall and the fastening pillar. The circuit board disposed to the rear of the button. The circuit board has a switch. The trigger portion is corresponding to the switch.

### BACKGROUND OF THE INVENTION

### Field of the Invention

The present invention generally relates to a button structure, and more particularly to a button structure having a better sensitivity and convenient operation.

### Description of Related Art

Generally, shoulder keys of a game controller are the most frequently used. The shoulder keys are symmetrically disposed to two opposite sides of the game controller. Each side of the game controller has an upper shoulder key and a lower shoulder key. The upper shoulder key and the lower shoulder key are used for executing different operations, respectively. The shoulder keys are usually pressed with an index finger.

A conventional shoulder key of a game controller includes an upper shoulder key and a lower shoulder key. The upper shoulder key and the lower shoulder key are disposed in a game pad. The upper shoulder key is adjacent to the lower shoulder key. An outer surface of the upper shoulder key is curved and convex. An outer surface of the lower shoulder key is curved and concave. The upper shoulder key has an upper silicone button. The lower shoulder key has a lower silicone button. The upper silicone button is detachably fixed to the upper shoulder key. The lower silicone button is detachably fixed to the lower shoulder key. The upper silicone button and the lower silicone button face toward a circuit board disposed in the game controller. The upper shoulder key and the lower shoulder key are hinged to the game pad. The upper shoulder key rotates horizontally along a hinge position. The lower shoulder key rotates vertically along the hinge position.

However, the outer surface of the upper shoulder key of the conventional shoulder keys is close to the hinge position. So, pressing the outer surface of the upper shoulder key is hard. The upper shoulder key of the conventional shoulder keys has low sensitivity, and the upper shoulder key is difficult to operate.

Thus, it is essential to provide an innovative button structure, the button structure having a better sensitivity and convenient operation.

### BRIEF SUMMARY OF THE INVENTION

An object of the present invention is to provide a button structure having a better sensitivity and convenient operation. The button structure includes a button, a supporting base and a circuit board. The button has a pressing portion, an elastic arm and a trigger portion. The elastic arm is extended rearward from one side of a rear of the pressing portion, and then is bent sideward, and then is extended frontward. The trigger portion is extended rearward from the rear of the pressing portion. The trigger portion is disposed beside the elastic arm. The supporting base disposed to a rear of the button. The supporting base has a surrounding wall and a fastening pillar. The fastening pillar is disposed in the surrounding wall. The elastic arm is disposed in the surrounding wall and is disposed between the surrounding wall and the fastening pillar. The circuit board disposed to the rear of the button. The circuit board has a switch. The trigger portion is corresponding to the switch.

Another object of the present invention is to provide a button structure. The button structure includes a button, a supporting base and a circuit board. The button has a pressing portion, an elastic arm and a trigger portion. The elastic arm is extended rearward from one side of a rear of the pressing portion, and then is bent sideward, and then is extended frontward. The trigger portion is extended rearward from the rear of the pressing portion. The trigger portion is disposed beside the elastic arm. The supporting base disposed to a rear of the button. The supporting base has a surrounding wall, a fastening pillar and a restricting block. The fastening pillar is disposed in the surrounding wall. The restricting block is protruded inward from a top of the surrounding wall. A top of the restricting block has an inclined surface. The elastic arm is guided by the inclined surface and then the elastic arm is assembled in the surrounding wall from a top of the supporting base, and the elastic arm is disposed between the surrounding wall and the fastening pillar and then the elastic arm is blocked by a bottom of the restricting block. The circuit board disposed to the rear of the button and is disposed above the supporting base. The circuit board has a switch. The trigger portion is corresponding to the switch.

Another object of the present invention is to provide a button structure. The button structure includes a button, a supporting base and a circuit board. The button has a pressing portion, an elastic arm and a trigger portion. The elastic arm has a first extending arm, a bending arm and a second extending arm. The first extending arm is extended rearward from a rear of the pressing portion. A rear end of the first extending arm is bent sideward to form the bending arm. A right end of the bending arm is extended frontward to form the second extending arm. A thickness of a junction between the bending arm and the second extending arm is gradually narrowed to form a transition section. The rear of the pressing portion is extended rearward to form the trigger portion. The trigger portion is disposed beside the elastic arm. The supporting base disposed to a rear of the button. The supporting base has a surrounding wall and a fastening pillar. The fastening pillar is disposed in the surrounding wall. The first extending arm, the bending arm, the transition section and the second extending arm are disposed between the surrounding wall and the fastening pillar. The circuit board disposed to the rear of the button. The circuit board is located above the supporting base. The circuit board has a switch. The trigger portion is corresponding to the switch. A thickness of the transition section is smaller than a thickness of the first extending arm. The thickness of the transition section is smaller than a thickness of the bending arm. The thickness of the transition section is bigger than a thickness of the second extending arm.

As described above, the fastening pillar is the pivoting shaft, and the button swings left and right along the fastening pillar. The ribs reinforce the rigidity of the first extending arm. The ribs prevent the button from rotating unexpectedly. The transition section reinforces the elasticity of the second extending arm. When the pressing portion of the button is pressed, the compressive stress of the elastic arm of the button is concentrated on the second extending arm and the transition section. The protruding block abuts against the outer surface of the free end of the second extending arm of the elastic arm, so the second extending arm of the elastic arm is preloaded. As a result, the button structure has a better sensitivity and convenient operation.

### BRIEF DESCRIPTION OF THE DRAWINGS

The present invention will be apparent to those skilled in the art by reading the following description, with reference to the attached drawings, in which:

FIG. 1 is a perspective view of a button structure in accordance with the present invention, wherein the button structure is in a released status;

FIG. 2 is a perspective view of the button structure, wherein the button structure is in a pressed status;

FIG. 3 is an exploded view of the button structure of FIG. 1; and

FIG. 4 is another exploded view of the button structure of FIG. 1.

### DETAILED DESCRIPTION OF THE INVENTION

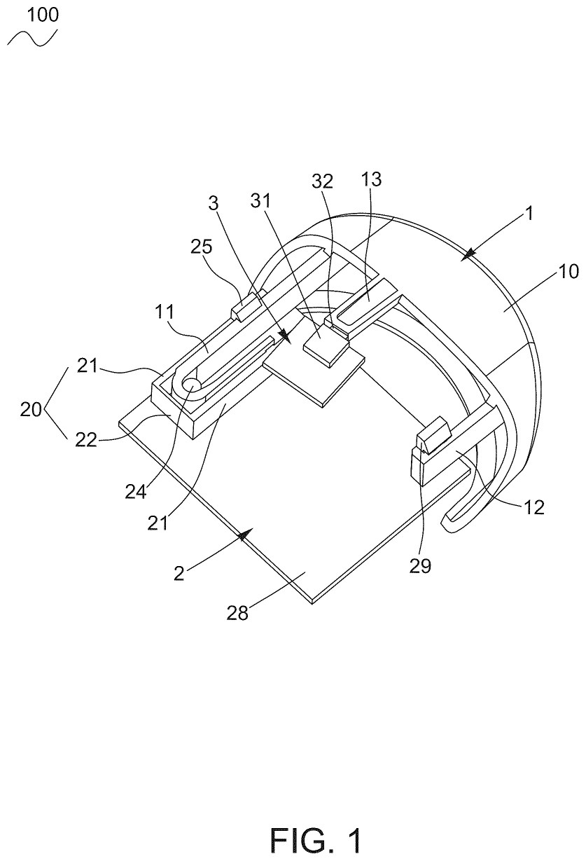

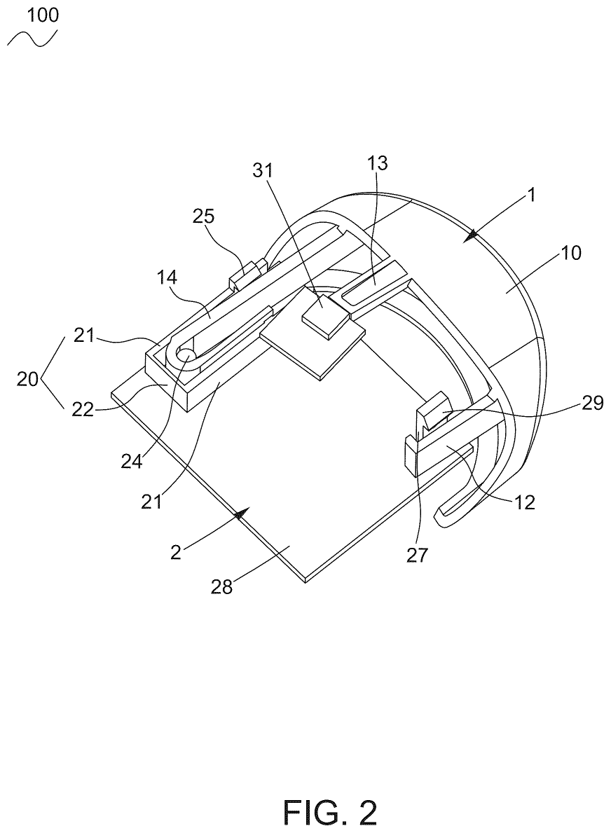

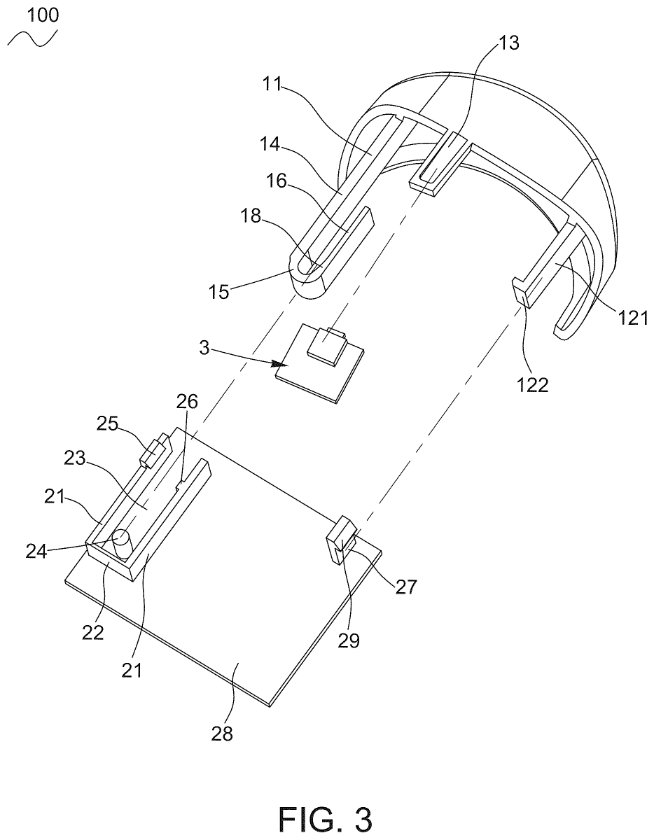

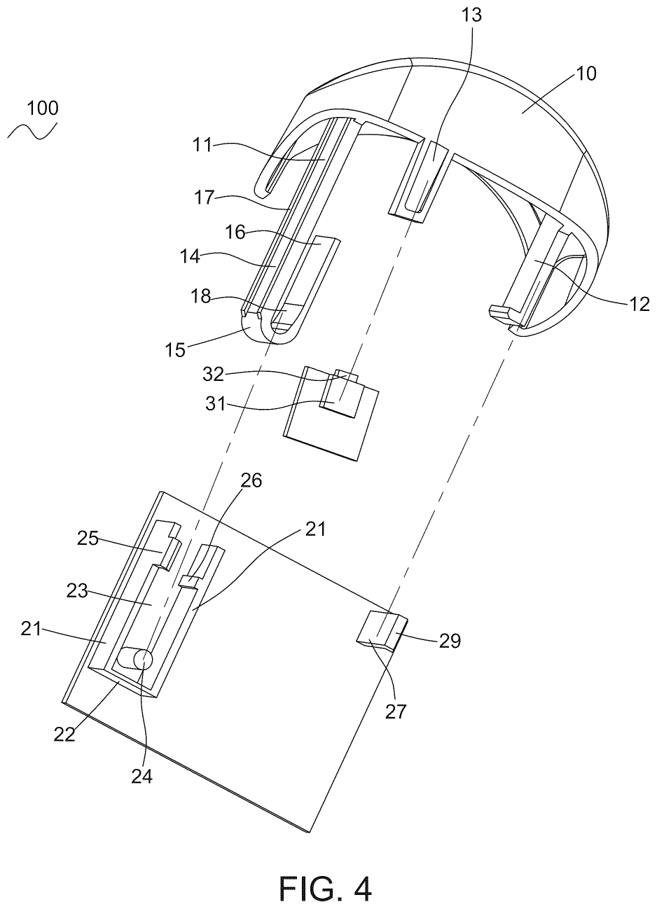

With reference to FIG. 1 to FIG. 4, a button structure 100 in accordance with the present invention is shown. The button structure 100 includes a button 1, a supporting base 2 and a circuit board 3. The button 1 is disposed in front of the supporting base 2. The button 1 is disposed in front of the circuit board 3. The circuit board 3 is located above the supporting base 2. The circuit board 3 is fastened in a frame of a game controller (not shown). The button 1 swings left and right along the supporting base 2.

The button 1 has a pressing portion 10, an elastic arm 11, a restricting arm 12 and a trigger portion 13. The elastic arm 11 is extended from a left side of a rear surface of the pressing portion 10. The restricting arm 12 is extended from a right side of the rear surface of the pressing portion 10. The trigger portion 13 is extended from a middle of the rear surface of the pressing portion 10. The trigger portion 13 is disposed between the elastic arm 11 and the restricting arm 12.

The elastic arm 11 has a first extending arm 14, a bending arm 15, a second extending arm 16, a plurality of ribs 17 and a transition section 18. The first extending arm 14 is extended rearward from the left side of the rear surface of the pressing portion 10. The bending arm 15 is extended from a rear end of the first extending arm 14, and the bending arm 15 is bent rightward. The second extending arm 16 is extended from a right end of the bending arm 15. The ribs 17 are protruded outward from an outer surface of the first extending arm 14. An extension direction of each rib 17 and an extension direction of the first extending arm 14 are the same. The ribs 17 reinforce a rigidity of the first extending arm 14. The ribs 17 prevent the button 1 from rotating unexpectedly. A thickness of a junction between the bending arm 15 and the second extending arm 16 is gradually narrowed to form the transition section 18. The thickness of the transition section 18 is smaller than a thickness of the first extending arm 14. The thickness of the transition section 18 is smaller than a thickness of the bending arm 15. The thickness of the transition section 18 is bigger than a thickness of the second extending arm 16. The transition section 18 reinforces an elasticity of the second extending arm 16. So, the elasticity of the second extending arm 16 is bigger than an elasticity of the first extending arm 14. When the pressing portion 10 of the button 1 is pressed, a compressive stress of the elastic arm 11 of the button 1 is concentrated on the second extending arm 16 and the transition section 18.

The restricting arm 12 has a third extending arm 121 and a hook portion 122. The third extending arm 121 is extended rearward from the right side of the rear surface of the pressing portion 10. A corresponding mechanism of the supporting base 2 is abutted against a top surface of the third extending arm 121. The hook portion 122 is extended leftward from a rear end of the third extending arm 121. The hook portion 122 abuts against the corresponding mechanism of the supporting base 2. The restricting arm 12 is parallel to the elastic arm 11. The first extending arm 14 is parallel to the third extending arm 121 of the restricting arm 12.

The supporting base 2 has a base board 28, two blocking walls 21, a connecting wall 22, a receiving space 23, a fastening pillar 24, a restricting block 25, a protruding block 26 and a blocking portion 27. The two blocking walls 21, the connecting walls 22, the receiving space 23, the fastening pillar 24, the restricting block 25, the protruding block 26 and the blocking portion 27 are disposed to a top surface of the base board 28. The two blocking walls 21 are extended upward from the top surface of the base board 28. The two blocking walls 21 are disposed to an outer side of the first extending arm 14 of the elastic arm 11 and an outer side of the second extending arm 16 of the elastic arm 11, respectively. The ribs 17 of the first extending arm 14 abut against an inner surface of one blocking wall 21. The connecting wall 22 is extended upward from the top surface of the base board 28. Two opposite ends of the connecting wall 22 are connected with rear ends of the two blocking walls 21. The connecting wall 22 is disposed to an outer side of the bending arm 15 of the elastic arm 11.

The receiving space 23 is surrounded among the two blocking walls 21 and the connecting wall 22. The elastic arm 11 is disposed in the receiving space 23. The fastening pillar 24 is extended upward from the top surface of the base board 28. The fastening pillar 24 is disposed in the receiving space 23. A position of the fastening pillar 24 is close to an inner surface of the connecting wall 22. The bending arm 15 of the elastic arm 11 is disposed between the connecting wall 22 and the fastening pillar 24. The fastening pillar 24 is a pivoting shaft. The button 1 swings left and right along the fastening pillar 24.

In the preferred embodiment, the two blocking walls 21 are connected with the connecting wall 22 to form a surrounding wall 20. The elastic arm 11 of the button 1 is disposed in the surrounding wall 20. The fastening pillar 24 is disposed in the surrounding wall 20. The elastic arm 11 of the button 1 is disposed between the surrounding wall 20 and the fastening pillar 24.

The restricting block 25 is protruded rightward from a top of the blocking wall 21. The restricting block 25 is blocked to a top surface of the first extending arm 14 of the elastic arm 11 of the button 1 to prevent the elastic arm 11 of the button 1 being separated from the surrounding wall 20. The protruding block 26 is protruded from an inner surface of the blocking wall 21. The protruding block 26 abuts against an outer surface of a free end of the second extending arm 16 of the elastic arm 11, so the second extending arm 16 of the elastic arm 11 is preloaded.

The blocking portion 27 is extended upward from the top surface of the base board 28. The blocking portion 27 is corresponding to the restricting arm 12 of the button 1. The blocking portion 27 is adjacent to an inner side of the third extending arm 121 of the restricting arm 12 of the button 1. A top of the blocking portion 27 protruded laterally to form a latch 29. The latch 29 is engaged to a top surface of the third extending arm 121 of the restricting arm 12 of the button 1 to prevent the restricting arm 12 being separated from the latch 29. The hook portion 122 of the restricting arm 12 abuts against a rear surface of the blocking portion 27 to prevent the hook portion 122 being separated from the blocking portion 27.

The circuit board 3 has a switch 31 disposed on a top surface of the circuit board 3. The switch 31 has a plunger 32 protruded from a front of the switch 31. The trigger portion 13 of the button 1 is corresponding to the plunger 32. When the pressing portion 10 of the button 1 is pressed, the trigger portion 13 of the button 1 presses the plunger 32 to generate a signal. The signal is transmitted to a processor which executes a command based on the signal.

As described above, the fastening pillar 24 is the pivoting shaft, and the button 1 swings left and right along the fastening pillar 24. The ribs 17 reinforce the rigidity of the first extending arm 14. The ribs 17 prevent the button 1 from rotating unexpectedly. The transition section 18 reinforces the elasticity of the second extending arm 16. When the pressing portion 10 of the button 1 is pressed, the compressive stress of the elastic arm 11 of the button 1 is concentrated on the second extending arm 16 and the transition section 18. The protruding block 26 abuts against the outer surface of the free end of the second extending arm 16 of the elastic arm 11, so the second extending arm 16 of the elastic arm 11 is preloaded. As a result, the button structure 100 has a better sensitivity and convenient operation.

What is claimed is:

1. A button structure, comprising:
a button having:
a pressing portion;
an elastic arm being extended rearward from one side of a rear of the pressing portion, and then being bent sideward, and then being extended frontward; and
a trigger portion being extended rearward from the rear of the pressing portion, the trigger portion being disposed beside the elastic arm;
a supporting base disposed to a rear of the button, the supporting base having a surrounding wall and a fastening pillar, the fastening pillar being disposed in the surrounding wall, the elastic arm being disposed in the surrounding wall and being disposed between the surrounding wall and the fastening pillar; and
a circuit board disposed to the rear of the button, the circuit board having a switch, the trigger portion being corresponding to the switch.

2. The button structure as claimed in claim 1, wherein the elastic arm has a first extending arm, a bending arm and a second extending arm, the first extending arm is extended rearward from the one side of the rear of the pressing portion, the bending arm is bent rightward from a rear end of the first extending arm, the second extending arm is extended frontward from a right end of the bending arm, the first extending arm, the bending arm and the second extending arm are disposed between the surrounding wall and the fastening pillar.

3. The button structure as claimed in claim 2, wherein the supporting base has a base board, the surrounding wall has two blocking walls and a connecting wall, the two blocking walls are extended upward from a top surface of the base board, the connecting wall is extended upward from the top surface of the base board, two opposite ends of the connecting wall are connected with rear ends of the two blocking walls, the fastening pillar is extended upward from the top surface of the base board, the fastening pillar is disposed between the two blocking walls and the connecting wall, the bending arm of the elastic arm is disposed between the connecting wall and the fastening pillar, the first extending arm of the elastic arm is disposed between the two blocking walls and the fastening pillar, the second extending arm of the elastic arm is disposed between the two blocking walls and the fastening pillar.

4. The button structure as claimed in claim 3, wherein the supporting base has a restricting block protruded laterally from a top of one blocking wall, the restricting block is blocked to a top surface of the first extending arm, the supporting base has a protruding block protruded inward from an inner surface of the other blocking wall extends, the protruding block abuts against an outer surface of the second extending arm.

5. The button structure as claimed in claim 4, wherein the elastic arm has a plurality of ribs protruded outward from an outer surface of the first extending arm, the ribs of the elastic arm abut against an inner surface of the one blocking wall.

6. The button structure as claimed in claim 2, wherein a thickness of a junction between the bending arm and the second extending arm is gradually narrowed to form a transition section.

7. The button structure as claimed in claim 6, wherein a thickness of the transition section is smaller than a thickness of the first extending arm, the thickness of the transition section is smaller than a thickness of the bending arm, the thickness of the transition section is bigger than a thickness of the second extending arm.

8. The button structure as claimed in claim 1, wherein the button has a restricting arm extended rearward from the other side of the rear of the pressing portion, the restricting arm has a third extending arm and a hook portion, the third extending arm is extended rearward from the other side of the rear of the pressing portion, the hook portion is protruded leftward from a rear of the third extending arm, the supporting base has a blocking portion, the blocking portion is corresponding to the restricting arm, a latch is extended from a top of the blocking portion, the latch is engaged to a top surface of the third extending arm of the restricting arm, the hook portion of the restricting arm abuts against a rear surface of the blocking portion.

9. A button structure, comprising:
a button having:
a pressing portion;
an elastic arm being extended rearward from one side of a rear of the pressing portion, and then being bent sideward, and then being extended frontward; and
a trigger portion being extended rearward from the rear of the pressing portion, the trigger portion being disposed beside the elastic arm;
a supporting base disposed to a rear of the button, the supporting base having a surrounding wall, a fastening pillar and a restricting block, the fastening pillar being disposed in the surrounding wall, the restricting block being protruded inward from a top of the surrounding wall, a top of the restricting block having an inclined surface, the elastic arm being guided by the inclined surface and then the elastic arm being assembled in the surrounding wall from a top of the supporting base, and the elastic arm being disposed between the surrounding wall and the fastening pillar and then the elastic arm being blocked by a bottom of the restricting block; and
a circuit board disposed to the rear of the button and being disposed above the supporting base, the circuit board having a switch, the trigger portion being corresponding to the switch.

10. The button structure as claimed in claim 9, wherein the elastic arm has a first extending arm, a bending arm and a second extending arm, the first extending arm is extended rearward from the one side of the rear of the pressing portion, the bending arm is bent rightward from a rear end of the first extending arm, the second extending arm is extended frontward from a right end of the bending arm, the first extending arm, the bending arm and the second extending arm are disposed between the surrounding wall and the fastening pillar, the first extending arm of the elastic arm is guided by the inclined surface and then the elastic arm is assembled in the surrounding wall from the top of the supporting base.

11. The button structure as claimed in claim 9, wherein the button has a restricting arm extended rearward from the other side of the rear of the pressing portion, the trigger portion is disposed between the elastic arm and the restricting arm, the restricting arm has a third extending arm and a hook portion, the third extending arm is extended rearward from the other side of the rear of the pressing portion, the hook portion is protruded leftward from a rear of the third extending arm, the supporting base has a blocking portion, the blocking portion is corresponding to the restricting arm, a latch is extended from a top of the blocking portion, a top of the latch has a slanted surface, the restricting arm is guided by the slanted surface of the latch and then is engaged with the restricting arm, the latch is engaged to a top surface of the third extending arm of the restricting arm, the hook portion of the restricting arm abuts against a rear surface of the blocking portion.

12. The button structure as claimed in claim 10, wherein a thickness of a junction between the bending arm and the second extending arm is gradually narrowed to form a transition section.

13. The button structure as claimed in claim 12, wherein a thickness of the transition section is smaller than a thickness of the first extending arm, the thickness of the transition section is smaller than a thickness of the bending arm, the thickness of the transition section is bigger than a thickness of the second extending arm.

14. The button structure as claimed in claim 10, wherein the supporting base has a base board, the surrounding wall has two blocking walls and a connecting wall, the two blocking walls are extended upward from a top surface of the base board, the connecting wall is extended upward from the top surface of the base board, two opposite ends of the connecting wall are connected with rear ends of the two blocking walls, the fastening pillar is extended upward from the top surface of the base board, the fastening pillar is disposed between the two blocking walls and the connecting wall, the bending arm of the elastic arm is disposed between the connecting wall and the fastening pillar, the first extending arm of the elastic arm is disposed between the two blocking walls and the fastening pillar, the second extending arm of the elastic arm is disposed between the two blocking walls and the fastening pillar.

15. The button structure as claimed in claim 14, wherein the elastic arm has a plurality of ribs protruded outward from an outer surface of the first extending arm, the ribs of the elastic arm abut against an inner surface of the one blocking wall.

16. A button structure, comprising:
a button having a pressing portion, an elastic arm and a trigger portion, the elastic arm having a first extending arm, a bending arm and a second extending arm, the first extending arm being extended rearward from a rear of the pressing portion, a rear end of the first extending arm being bent sideward to form the bending arm, a right end of the bending arm being extended frontward to form the second extending arm, a thickness of a junction between the bending arm and the second extending arm being gradually narrowed to form a transition section, the rear of the pressing portion being extended rearward to form the trigger portion, the trigger portion being disposed beside the elastic arm;
a supporting base disposed to a rear of the button, the supporting base having a surrounding wall and a fastening pillar, the fastening pillar being disposed in the surrounding wall, the first extending arm, the bending arm, the transition section and the second extending arm being disposed between the surrounding wall and the fastening pillar; and
a circuit board disposed to the rear of the button, the circuit board being located above the supporting base, the circuit board having a switch, the trigger portion being corresponding to the switch;
wherein a thickness of the transition section is smaller than a thickness of the first extending arm, the thickness of the transition section is smaller than a thickness of the bending arm, the thickness of the transition section is bigger than a thickness of the second extending arm.
